(19) United States
(12) Patent Application Publication
(10) Pub. No.: US 2003/0091151 A1
(43) Pub. Date: May 15, 2003

(54) Universal radiography system

(76) Inventors: Heinz Horbaschek, Erlangen (DE); Claudius Molz, Buckenhof (DE)

Correspondence Address: SCHIFF HARDIN & WAITE, 6600 SEARS TOWER, 233 S WACKER DR, CHICAGO, IL, 60606-6473, US

(21) Appl. No.: 10/271,298

(22) Filed: Oct. 15, 2002

(30) Foreign Application Priority Data
Oct. 15, 2001 (DE) 10150794.1

(51) Int. Cl. H05G 1/02

(52) U.S. Cl. 378/196

(57) ABSTRACT

A universally employable radiography system has a first ceiling-suspended system for an X-ray radiator that is movable in the three spatial coordinates by means of the first ceiling-suspended system and is pivotable around at least two axes, a second ceiling-suspended system independent of the first for a radiation receiver that is movable in the three spatial coordinates by means of the second ceiling-suspended system, and a bracket, attached to the second ceiling-suspended system, at which the radiation receiver is suspended so as to be movable around at least two axes. The X-ray radiator and the radiation receiver can be positioned opposite one another.

### BACKGROUND OF THE INVENTION

1. Field of the Invention

The present invention is directed to a radiography system of the type having a ceiling-suspended system for an X-radiator that is displaceable in the three spatial coordinates by means of the ceiling-suspended system and is pivotable around at least two axes.

2. Description of the Prior Art

For exposures wherein a receiver is installed in a stationary patient table, exposures having a lateral or arbitrary radiation direction are not possible. These exposures must be implemented with cassettes, which, among other things, impede an optimized workflow.

Restrictions as to the possible exposures also exist in the case of known radiography systems wherein the X-ray radiator and the image receiver are arranged in common at a C-shaped or U-shaped carrier, i.e. are rigidly coupled to one another with respect to their spacing. This fixed coupling limits the examinations that can be implemented with the system to those that are possible with the coupling-dependent, predetermined spacing of the radiation source from the radiation receiver. In order to be able to also implement examinations with such a system wherein a larger focus-to-film distance is required, for example given thorax exposures wherein the distance must amount to approximately 1.80 m and more, a second radiation receiver is normally employed that, for example, is attached to a wall, for example, using a grid wall device. Thus in such augmented systems an image receiver is arranged both at the carrier and another image receiver is located at the grid wall device. This, of course, causes additional costs that are particularly significant given employment of a digital radiation receiver in the form of an image detector, which is considerably more expensive than a cassette grid drawer. Moreover, arrangements having such additional grid devices are not always employable for structural reasons.

### SUMMARY OF THE INVENTION

An object of the present invention is to provide a universal radiography system that enlarges the variability of the examinations that are implementable with the system, while also reducing the costs associated therewith.

This object is inventively achieved in a system of the type initially described having a second radiation receiver, particularly a digital image receiver, at a second ceiling-suspended system independent of the first ceiling-suspended system, so that the second radiation receiver is movable in the three spatial coordinates by means of the second ceiling-suspended system, and wherein the second radiation receiver is suspended from the second ceiling-suspended system by a bracket so as to be movable around at least two axes. The first and second radiation receivers thus can be positioned opposite each other. The X-ray radiator and the radiation receiver preferably are provided with motorized drives (universal employment, even though having certain adjustment problems, also can be achieved with manual movement of the X-ray radiator and/or of the image receiver) and the drives of the X-ray radiator and the radiation receiver can be provided with position acquisition devices and can be coupled to one another via adjustment software.

Inventively, the radiation receiver can be suspended so as to be movable around at least two horizontal axes of the bracket and rotatable around the vertical axis of the second ceiling-suspended system.

As a result of the ongoing position acquisition of all coordinates and angles and the use of suitable software, a coupling or a follow-up of the systems can ensue dependent on the desired application using the support devices or holding devices for the patient (patient support plate or patient support table for exposures at a lying or sitting patient, or handles for exposures at a standing patient, for example thorax exposures in two planes).

In the inventive system exposures at a seated patient from arbitrary irradiation angles are easily implemented as “contact exposures”, for example of the extremities, wherein the subject to be examined can be positioned directly at the housing of the digital radiation receiver.

In an embodiment of the invention the ceiling suspensions for the X-ray radiator and the image receiver are fashioned such that the X-radiator and the image receiver—positioned opposite one another—are rotatable around the patient, so that motion sequences as needed, for example, for tomography are possible. As is currently standard for cost reasons for the mechanisms, it is thereby not only linear slice sequences or slice figures are possible; but arbitrary circular, spiral, cycloidal, etc., slice sequences are also possible. The acquired datasets thus can serve for the reconstruction either of multiple planar slices (tomosynthesis) (with the slice planes being arbitrarily oriented in space) or large-volume 3-D presentations.

It is clear that the implementation of such exposures requires a suitable patient support mechanism having a radiation-transparent support plate that is suspended or supported at one side (cantilevered).

For registering larger regions, in an embodiment of the invention, such regions are covered by displacing the image receiver, which is smaller compared to the region to be registered, given simultaneous swiveling of the X-ray radiator. This avoids the need to use large-area cassettes, as is conventional

In order to avoid trapezoidal distortions, in a further embodiment of the present invention the image plane of the radiation receiver is tilted corresponding to the swivel of the central ray of the X-ray radiator.

### DESCRIPTION OF THE DRAWINGS

FIG. 1 is a schematic illustration of a ceiling-suspended X-ray radiator with the various motional and rotational axes, suitable for use in the inventive system.

FIG. 2 is a schematic illustration of the inventive ceiling suspension for the radiation receiver.

FIG. 3 is a schematic illustration of the swiveling and displacement of X-ray radiator and the radiation receiver for the registration of larger regions in accordance with the invention.

FIG. 4 shows a modified version of the exposure system according to FIG. 3 with additional tilting of the image plane corresponding to the swivel of the X-ray radiator.

FIGS. 5-8 respectively illustrate a few exemplary embodiments of typical applications of the inventive universal radiography system.

### DESCRIPTION OF THE PREFERRED EMBODIMENTS

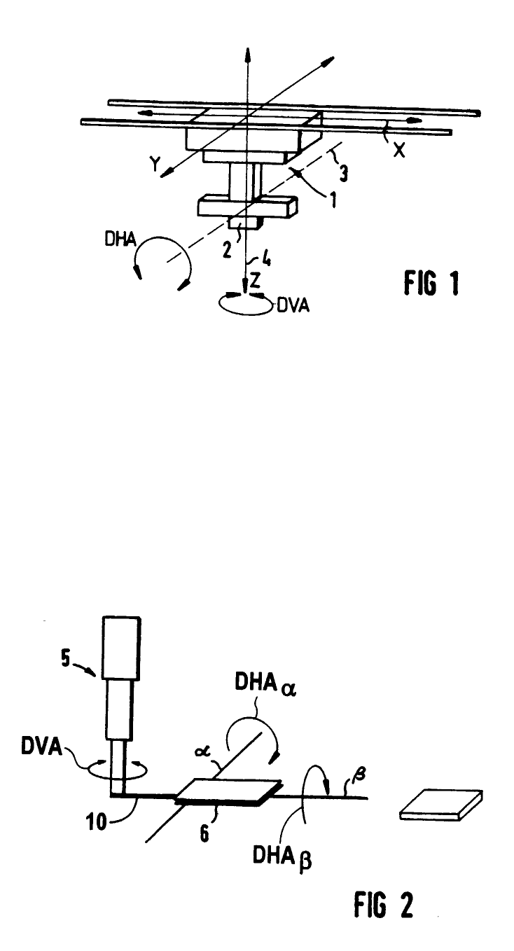

The ceiling-guided suspension system 1 for an X-ray radiator 2, shown in FIG. 1, a displacement along a longitudinal axis (x-axis), a transverse axis (y-axis) and a vertical axis (elevation or z-direction) as well as rotations or turns DHA around the horizontal axis 3 and rotations or turns DVA around the vertical axis 4.

The ceiling suspension system 5 schematically shown in FIG. 2 for a radiation receiver 6 held with a bracket 10, particularly a digital image receiver, identically enables displacements along the x-axis, y-axis and z-axis as well as rotations or turns DVA around he vertical axis (z-axis) and swiveling around the α-axis and the β-axis relative to the bracket 10.

Both ceiling suspension systems 1 and 5 preferably are provided with motorized drives (not shown) that are preferably fashioned such that free orientations of the X-radiator 1 and of the radiation receiver 6 in space are possible. The drives of the X-ray radiator 2 and of the radiation receiver 6 can be provided with position acquisition devices and can be coupled to one another via adjustment software such that the allocations of X-ray radiator 1 and the radiation receiver 6 needed for a particular application is automatically set every orientation.

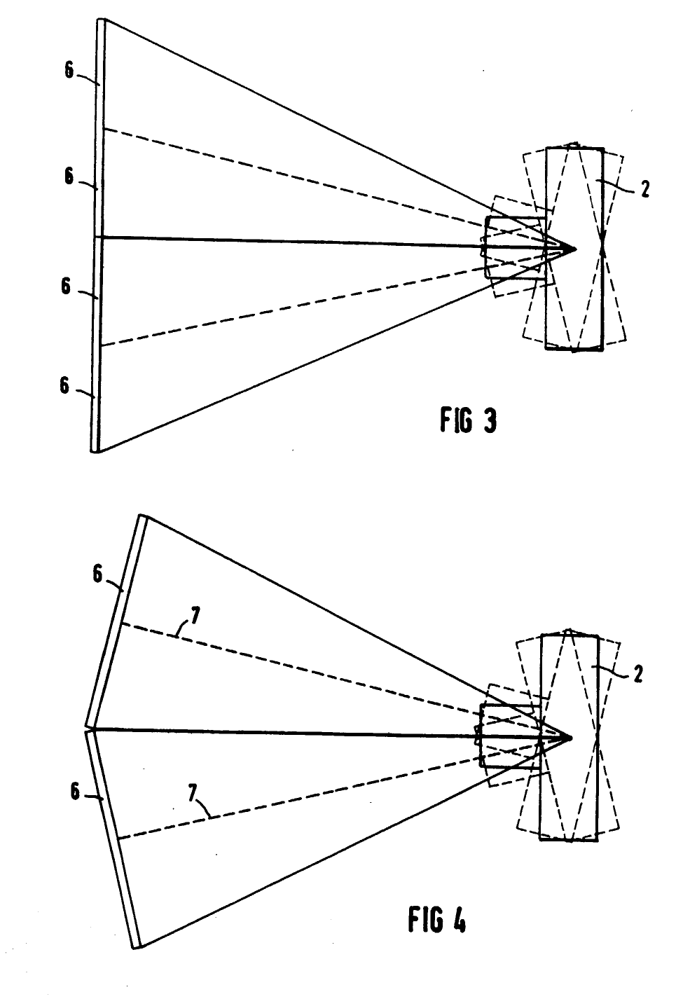

As shown in FIG. 3, for example, for covering larger exposure regions compared to the area of the radiation receiver 6, the radiation receiver 6 is displaced in the image plane while the X-ray radiator 2 is simultaneously tilted. In order to avoid trapezoidal distortions, as schematically indicated in FIG. 4, a corresponding tilting (rather than only a displacement of the radiation receiver 6) can simultaneously ensue together with (tracking) the tilting of the radiation receiver 6, so that the central ray 7 of the X-radiator 2 is mounted at a perpendicular intersection of the image plane of the image receiver 6.

FIGS. 5 through 8 show four different applied examples for radiography exposures with the inventive universal system, with simultaneous employment of a patient support mechanism 8 that has a radiation-transparent support plate 9 supported at one side.

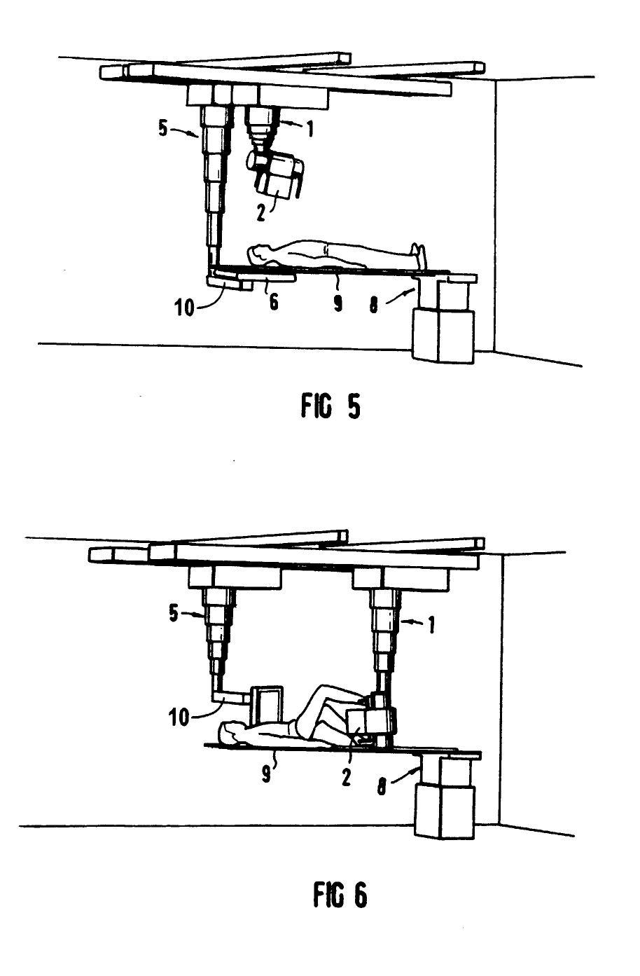

FIG. 5 shows an axial skull exposure situation, whereas FIG. 6 axially shows femoral neck exposure that can be set by means of a corresponding displacement of the ceiling suspension systems 1 and 5.

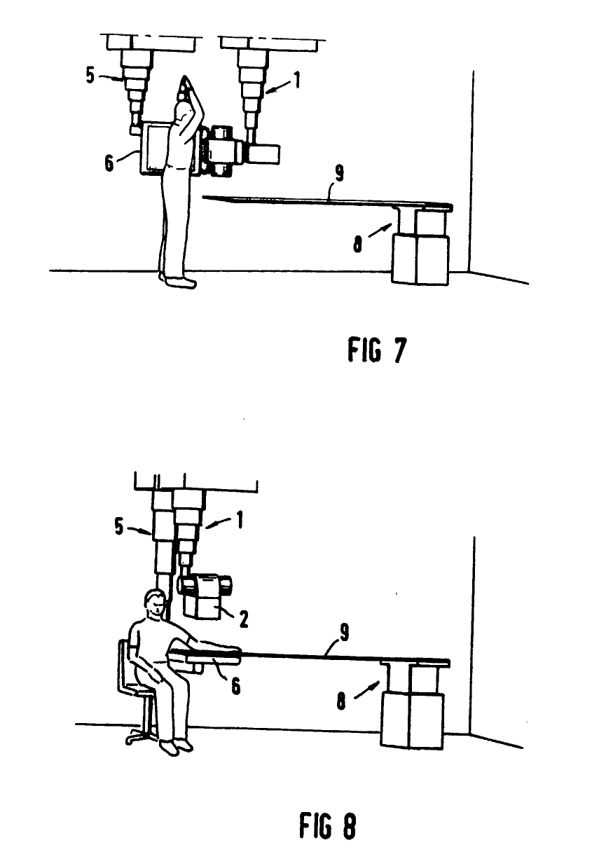

FIG. 7 shows the arrangement of X-ray radiator 2 and radiation receiver 6 for a lateral thorax exposure, and FIG. 8 shows the positioning of the ceiling suspension systems 1 and 5 with the X-ray radiator 2 and the radiation receiver 6 respectively secured thereto for an elbow examination.

Although modifications and changes may be suggested by those skilled in the art, it is the intention of the inventors to embody within the patent warranted hereon all changes and modifications as reasonably and properly come within the scope of their contribution to the art.

We claim as our invention:

1. A radiography system comprising:
an X-ray radiator;
a first ceiling-suspended system to which said X-ray radiator is mounted allowing selective positioning of said X-ray radiator in three orthogonal directions and rotation of said X-ray radiator around at least two axes;
a radiation receiver;
a second ceiling-suspended system;
a bracket mounting said radiation receiver to said second ceiling-suspended system, said second ceiling-suspended system allowing selective positioning of said radiation receiver in said three spatial directions and said bracket allowing rotation of said radiation receiver around at least two axes of said bracket; and
said X-ray radiator and said radiation receiver being positionable opposite each other.

2. A radiography system as claimed in claim 1 wherein said bracket has at least two horizontal axes around which said radiation receiver is rotatable, and wherein said second ceiling-suspended system has a vertical axis around which said radiation receiver also is rotatable.

3. A radiography system as claimed in claim 1 wherein said radiation receiver is a digital image receiver.

4. A radiography system as claimed in claim 1 wherein said first ceiling-suspended system comprises motorized drives for positioning said X-ray radiator in said orthogonal directions and wherein said second ceiling-suspended system comprises motorized drives for positioning said radiation receiver in said orthogonal directions, and wherein said radiography system further comprises a control unit and wherein said X-ray radiator and said radiation receiver each have position acquisition devices associated therewith for supplying signals to said control unit identifying respective positions of said X-ray radiator and said radiation receiver, and wherein said control unit operates using adjustment software, dependent on said signals, to couple said X-ray radiator and said radiation receiver.

5. A radiography system as claimed in claim 1 further comprising a patient support mechanism adapted to receive a patient thereon for irradiation with X-rays from said X-ray radiator, said patient support mechanism having a base with a radiation-transparent support plate attached cantilevered to said base.

6. A radiography system as claimed in claim 5 wherein each of said first and second ceiling-suspended systems is disposed relative to said patient support mechanism to allow rotation of said X-ray radiator and said radiation receiver, disposed opposite each other, around a patient on said patient support mechanism.

7. A radiography system as claimed in claim 1 wherein said first and second ceiling-suspended systems are operable in coordination with each other to displace said radiation receiver while simultaneously rotating said X-ray radiator to expose a region having an area larger than an area of said radiation receiver.

8. A radiography system as claimed in claim 7 wherein said radiation receiver has an image plane, and wherein said first and second ceiling-suspended systems are operable to maintain a central ray emitted from said X-ray radiator perpendicular to said image plane.
